(19) United States
(12) Patent Application Publication
(10) Pub. No.: US 2010/0191959 A1
(43) Pub. Date: Jul. 29, 2010

(54) Secure microprocessor and method

(75) Inventor: David R. Czajkowski, Encinitas, CA (US)

Correspondence Address: Continuum Law, 10085 Carroll Canyon Rd Suite 100, San Diego, CA, 92131-1100, US

(73) Assignee: Space Micro Inc.

(21) Appl. No.: 12/655,885

(22) Filed: Jan. 7, 2010

Related U.S. Application Data
(63) Continuation-in-part of application No. 11/366,373, filed on Mar. 3, 2006, now abandoned.
(60) Provisional application No. 60/719,563, filed on Sep. 23, 2005.

(51) Int. Cl. G06F 21/00; H04L 9/00

(52) U.S. Cl. 713/155; 713/190

(57) ABSTRACT

A method and reconfigurable computer architecture protect binary opcode, or other data and instructions by providing an encryption capability integrated into an instruction issue unit of a protected processor. Opcodes are encrypted at their source, and encrypted opcodes from authorized users are then delivered to a CPU and decrypted “inside” the CPU. Access into the CPU is prevented. Each form of code or data selected for protection is protected from unauthorized viewing or access. Commonly, the binary executable, or object, code is selected for protection. However, protected information could also include source code or data sets or both. Encrypting opcodes will result in making unique opcodes for each processor. Encryption keys and hidden opcode algorithms provide further security.

### CROSS REFERENCE TO RELATED APPLICATIONS

The present application is a continuation-in-part U.S. patent application Ser. No. 11/366,373, filed Mar. 3, 2006, which in turn claims priority from U.S. Provisional Patent Application Ser. No. 60/719,563, filed Sep. 23, 2005, which is incorporated by reference herein in its entirety.

### FIELD OF THE INVENTION

The present subject matter relates to an apparatus and method for protecting software in binary format or interim data set solutions from reverse engineering, and in a further form to permit operation of individual software programs only on authorized specific microprocessors by authorized persons.

### BACKGROUND OF THE INVENTION

Reconfigurable computing hardware is programmable to provide a wide range of functions. The present discussion will refer to microprocessors since they are a prevalent form of reconfigurable hardware. However, the considerations discussed are applicable to many forms of reconfigurable computing hardware. Unique capabilities of microprocessors are enabled through the use of operation codes, also known as opcodes or instruction sets. Since the operation codes represent significant value, it is important to protect the operation codes from reverse engineering as well as from outright copying. Interim data set solutions also need to be protected. Even when instructions are embedded in a processor and are not designed to be output from the processor, reverse engineering is possible. Various techniques for probing the processor have been employed in order to extract the operation codes.

Strong forms of encryption have been used for messages. Both symmetric and asymmetric encryption have been accepted by the United States National Institute of Standards and Technology (NIST). Symmetric programs include Triple Data Encryption Standard (3DES) and Advanced Encryption Standard (AES). Asymmetric programs include RSA (named for inventors of the program) and Diffie-Hellman. RSA is based on the factorization of large prime numbers. Calculation in one direction is simple; the reverse, however, is very complicated. Encryption of messages applies mathematical programs to blocks of data. The 3DES and RSA programs require a unique key as part of the input process. For 3DES key length is typically 168 bits, while RSA typically requires 1024 bit keys. This makes the resulting protected unique opcode very random in nature and very protected. Various techniques have been provided in the prior art to protect object code and to protect selected results. Due to the need to provide for unimpeded operation with limited complexity in hardware, only relatively simple encryption programs have been utilized.

United States Published Patent Application 2003/0233560 discloses a method for protecting a program in a microcomputer. An encrypted program and decoding key data are stored in a memory. Instructions are configured to be decoded when the encrypted instruction is called for by the processor. A control circuit controls a central processing unit (CPU) and the memory so that the memory reads out key data while the CPU is in a wait state. Then the instruction is decrypted and performed. The decrypted instruction is provided on a bus, and is not confined within the processor. Encryption is performed by using codes such as rotating or replacement codes. These are among the simpler forms of encryption to overcome. Recognized strong forms of encryption are not used.

United States Published Patent Application 2005/00005157 discloses a CPU provided with an ability to modify its operation in accordance with an encryption key. When a program is compiled, the program is modified. The program may be performed on a CPU as modified. An instruction buffer on a keyed microprocessor contains logic which is able to route a subset of the instruction bits on the microprocessor. Encrypted opcodes are combined with camouflage or surplus bits. A resulting code string has its bits permuted according to the key. A resulting bit string is then gathered into long instruction words, such as 128 bit words, and these long words are gathered into multi-word groups that will fit in the instruction buffer of the CPU. Some camouflage bits are replaced by interdependency bits that will be dependent on other interdependency bits in other long instruction words. These encrypted long instruction words are distributed without further protection to the CPU having a matching key configuration. Again, traditional strong encryption keys such as those used in privacy protection schemes are not used.

United States Published Patent Application 2004/0111717 discloses a software modification method in which a public key encryption process is utilized. A self-contained instruction set is selected from software. When executed, the selected self-contained instruction set is executed in a separate processor. This system does not permit confining the decoding and execution of instruction within a single processor.

One technique for protecting data or instructions is called result obfuscation. U.S. Pat. No. 6,665,796 discloses a CPU which executes program instructions which result in valid and invalid intermediate results. By selecting desired intermediate results, a program is successfully executed. Analysis of the intermediate results must avoid plausible wrong results. A programmable feature allows an instruction decoder to provide plural answers, including plausible wrong answers. Instruction output selection logic selects a predetermined buffer, and this permits further microprocessor operation with the correct intermediate result. While results are given some protection from copiers, strong encryption is not provided.

Obfuscation is also used to protect instructions in the form of application code. United States Patent Application 2006/0031686 discloses a method of protecting host application code comprising a plurality of code blocks. The method includes steps of preprocessing the host application code, obfuscating the host application code, installing guards in the host application code to protect client blocks, randomly rearranging the code blocks of the host application code and linking the rearranged host application code with other resources to produce a binary executable image. The prior art methods do not provide a strong rigorous method applicable to object code, source code and data.

### SUMMARY OF THE INVENTION

Briefly stated, in accordance with embodiments of the present invention a method and reconfigurable computer architecture protects binary opcode, or other data and instructions, by providing an encryption capability integrated into an instruction issue unit of each processor (CPU). Opcodes are encrypted at their source, and encrypted opcodes are then delivered to the CPU and decrypted “inside” the CPU. Access into the CPU is prevented. Each form of code or data selected for protection is protected from unauthorized viewing or access. Commonly, the binary executable, or object, code is selected for protection. However, protected information could also include source code or data sets or both. Encrypting opcodes will result in making unique opcodes for each processor.

In one form, a protected program is sent in a message over a network to a selected user associated with a CPU from, e.g., a software developer or an administrator. CPUs in a system may each have a unique, machine-readable identifier. The identity of the CPU is encoded in the message in accordance with a format for the system. Consequently, only the authorized CPU may download and decrypt the protected program. Also, the CPU will not be able to install programs not encoded in the system. Such uninstalled programs may include viruses. In order to enable the CPU to decrypt the message, the CPU sends a message including its identity to an authentication server. If the identity is registered as authorized, with the authentication server a decryption key is sent to the CPU so the protected program can be decrypted and downloaded.

In a further form, the CPU can be also used to create secure external memory, by encrypting the data inside of the CPU and then storing the encrypted data in an external memory. To read the encrypted data stored externally, the CPU reads the encrypted data back into the CPU, decrypts it and then uses it.

### BRIEF DESCRIPTION OF THE DRAWINGS

The present subject matter may be further understood by reference to the following description taken in connection with the following drawings:

FIG. 1 is a block diagram of a nominal operating environment in which embodiments of the present invention may be utilized;

FIG. 2 is a block illustrating architecture of a protected processor according to an embodiment of the present invention;

FIG. 3 is a hardware block diagram of an implementation of the architecture of FIG. 2;

FIG. 4 is a block diagram illustrating integration of a protected processor with a reconfigurable processor;

FIG. 5 is a block diagram illustrating encoding of opcodes;

FIG. 6 is a chart illustrating a format of an encrypted message sent from one protected processor to another;

FIG. 7 is a flow chart illustrating decryption of the message of FIG. 6;

FIG. 8 is a chart showing a graphical user interface useful in encrypting a message;

FIGS. 9 is a block diagram illustrating incorporation of encryption and decryption keys in one form of FPGA processor;

FIGS. 10 is a block diagram illustrating an architecture with further safeguards;

FIG. 11 is an illustration of a portable key device;

FIG. 12 is a functional block diagram illustrating operation in a key-protected environment;

FIG. 13 is a block diagram illustrating provision of a key to a work station in response to transmission of an opcode by an authorized user.

FIG. 14 is a block diagram illustrating of one form of authentication server.

### DETAILED DESCRIPTION

Embodiments of the present invention will provide for processors which can safely store code and which are protected from reverse engineering. Processors may also be programmed by code transmitted by a developer at a remote location, and software may be maintained by an administrator at a remote location. The protected processor may be made accessible to a user either on a users own server or via a hosted service accessed through the Internet or other network.

This is particularly significant in the context of reconfigurable computer architecture. A reconfigurable computing system compiles program source code to an intermediate code suitable for programming runtime processors or reconfigurable field-programmable gate arrays, enabling a software design to be implemented directly in hardware. Since many different hardware-implemented programs can potentially perform in parallel, a reconfigurable computing system can be considered an advanced parallel processing architecture. Reconfigurable computing could also be categorized as computing in memory. This terminology alludes to the function of the neuronal brain, where the processor and the memory cannot be distinguished from each other.

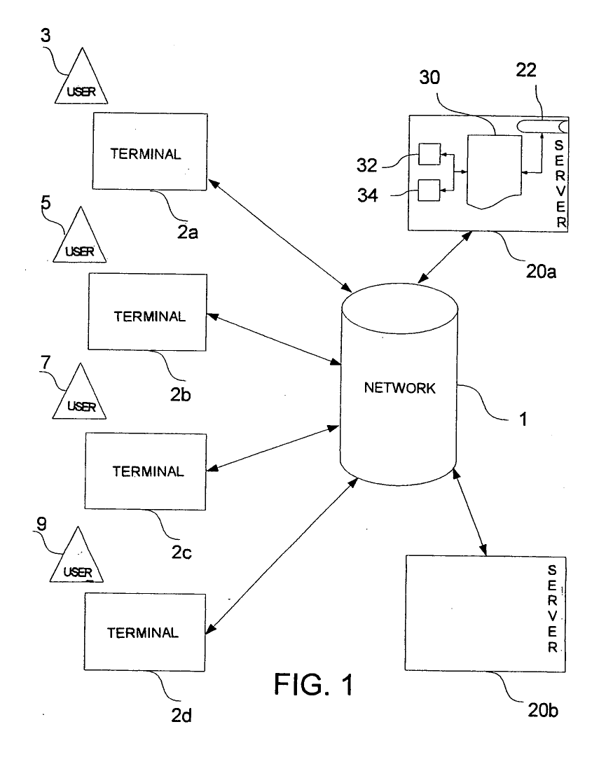

FIG. 1 is a block diagram of a reconfigurable processing device in an operating environment in which embodiments of the present invention may be utilized. Many different workstations 2, each belonging to a different class of entity, may communicate over a network 1. The network 1 may comprise the Internet or other wide area network (WAN) or a combination of networks. Different classes of entities may share or use separate workstations 2. For purposes of the present description, a developer 3 is shown at a workstation 2a, an administrator 5 is at a workstation 2b, and a program user 7 is at a workstation 2c. Threats to the software and data to be protected may come in many forms. One common form of access by threat entities is via the network 1. Therefore, a threat 9 is illustrated as a workstation 2d. Each class of entities may access or seek to access computing platforms 20 containing “high value” programs. High value refers to a computer program for which protection as further described below is cost-justified. The platforms 20 may also contain fixed data and may produce computational data requiring protection. Commonly, the platforms 20 comprise servers. In the present illustration, servers 20a and 20b are provided.

Developers 3 work with software development tools. These tools often comprise open software development tools as well as proprietary modules. In particular, a developer 3 will include code, commonly in the form of source code which will provide software with a particular capability in a computation environment. Real or simulated data sets may also be provided. Applications encompassing a computational environment could include, for example, radar signature predictions, signal or image processing or other computations. The primary elements associated with the developer 3 that require protection are the developed program, its conversion into binary and its transfer to the administrators 5 for use by others. When the developed program or its binary output is protected, it becomes a “protected” program. Protection may include making a protected unique binary opcode output.

Administrators 5 work with the software tools and with the programs developed by the developers 3. Administrators 5 maintain hardware platforms and software. In different situations, administrators 5 could also be the developers 3 or network user 7. Users 7 work with data sets. The data sets may comprise input raw data or data calculated by protected programs. Some data sets might be distributed to the user 7's protected workstation 2c that needs protection from threats. Since the user 7 must also create additional inputs that are not protected as inputs, all interim results that are loaded or stored are to be protected from threats. Further alternatively, an administrator 5 may be an untrusted middleman comprising a threat 9. In transactions connected with an administrator 5, it is to be assumed that the protected program needs unique opcode protection.

The present illustration shows servers 20a and 20b. Each server 20 comprises a protected processor 30. Embodiments of the present invention are particularly suited for use with configurable processors. Configurable processors include fixed processors, field programmable gate arrays (FPGAs) and matrix array processors. The server 20 may provide an interface to the protected processor 30 from the unprotected outside environment via a data bus 22. The protected processor 30 communicates with a data memory 32 and an instruction memory 34. The data memory 32 and an instruction memory 34 are on a protected side of the protected processor 30.

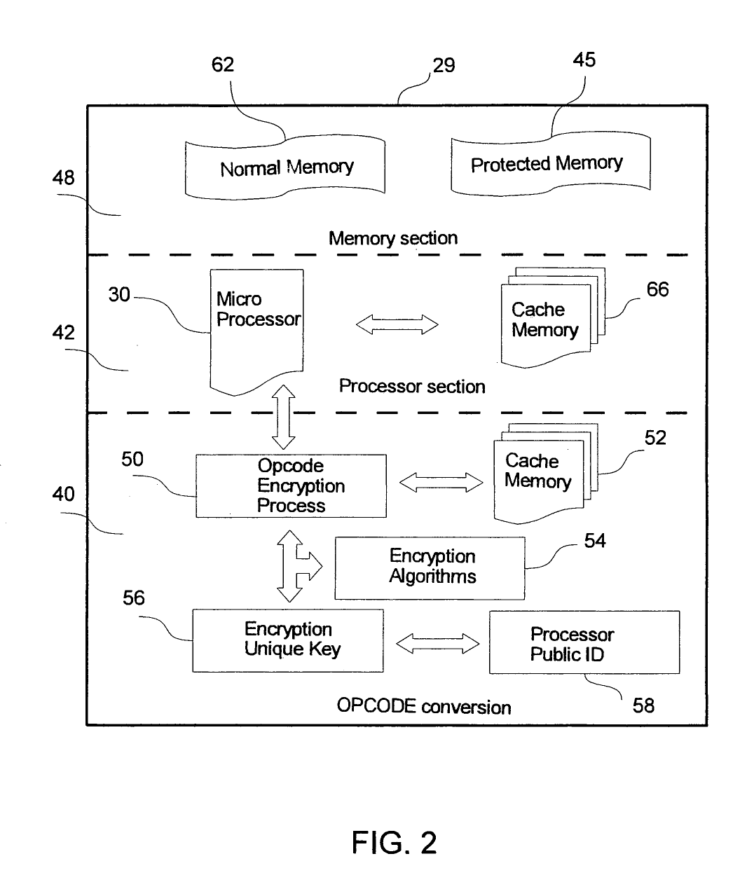

FIG. 2 is a block diagram of a form of computer architecture 29 for a protected processor 30 according to an embodiment of the present invention. In the present illustration, encryption needs to be located at the workstation 2a of the developer 3 and at each protected processor 30. The workstation 2a comprises a protected processor 30a. Encryptions for the developer 3 are software encryption modules that are run on the standard output of the binary after it is completed through standard software development tools. Consequently, encryption may be readily interfaced to legacy systems to implement embodiments of the present invention. The architecture 29 comprises an opcode conversion section 40, a processor section 42, and a memory section 48. The memory section 48 comprises an accessible memory 22 and a protected memory 45. The processor section 42 is accessible only via the opcode conversion section 40.

The opcode conversion section 40 comprises an opcode encryption process 50 utilizing a cache memory 52. Encryption algorithms 54 are provided. A unique encryption key 56 is used to enable encryption. In selected embodiments, a processor public identification 58 may be used in conjunction with the encryption key 56. The encryption process 50 encrypts data and instructions provided from a microprocessor 64, or such processing unit, which may utilize a cache memory 66.

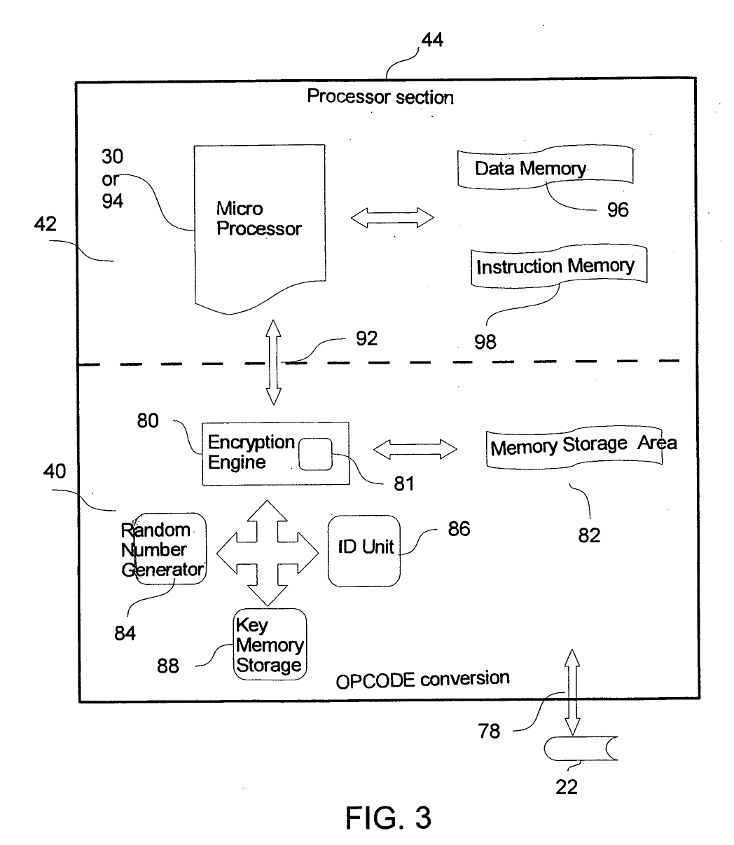

FIG. 3 is a block diagram of a hardware embodiment of the architecture illustrated in FIG. 2. The encryption for each protected processor 30 must be located at each instruction issue unit in the protected processor 30 hardware itself. Unique opcode conversion will consist of an opcode encryption process, encryption algorithm and key. The processor will have the same functional unit set as required to match the developer 3's standard software development tools. Protection will result from encryption of the opcode at the developer 3's system and from decryption of the protected opcode by an instruction issue unit in the protected side of the protected processor 30.

FIG. 3 is a block diagram of a hardware embodiment of the architecture illustrated in FIG. 2. As in the architecture of FIG. 2, there is an opcode conversion section 40 and a processor section 42 housed in a physical structure 44. The physical structure 44 represents one embodiment that may be incorporated in a server such as server 20a or 20b. In this architecture, the opcode conversion section 40 acts as a “shield” or “wall” that controls access to the processor section 42. Instructions and data are moved through the opcode conversion section 40, encrypting the instructions and data in an “out” direction and decrypting in an “in” direction. This allows the use of industry standard opcodes and memory in the processor section 42.

The opcode conversion section 40 operates as an instruction issue unit in the protected processor 94 hardware, and will issue decrypted instructions to the processor section 42. In addition, data memory and interim data disk accesses can be encrypted on exit from and decrypted on entry to the opcode conversion section 40. The protected processor 94 should have a functional unit set that will match standard software development tools of the developer 3. Protection will result from encryption of the opcode at the developer 3's workstation 2a and decryption at the protected processor 94.

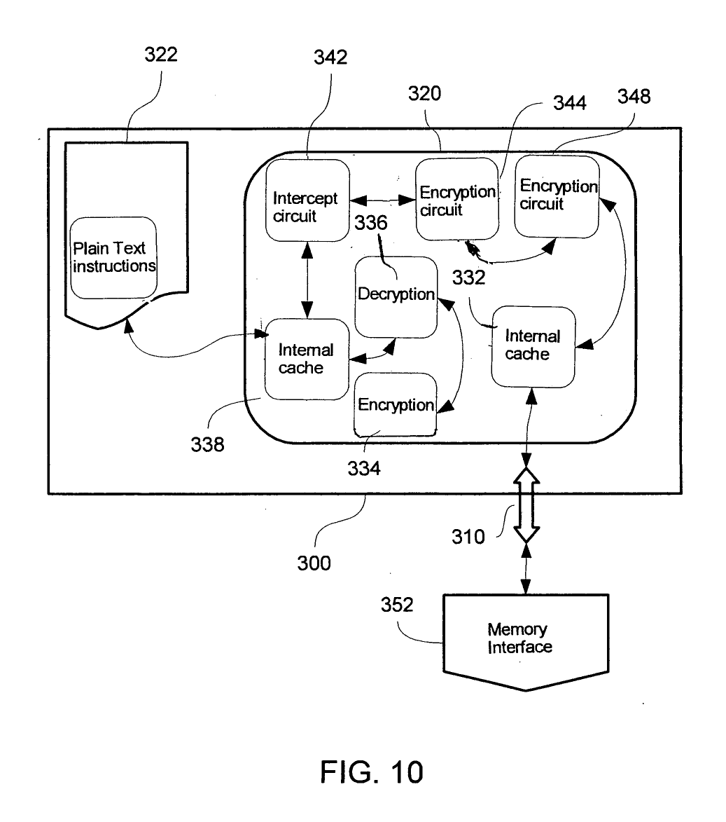

In order to provide for encryption/decryption, an encryption engine (EE) 80 is coupled to the data bus 22 by a connector 78. The encryption engine 80 will preferably include an industry standard encryption/decryption algorithm and encryption key management algorithms. A memory storage area 82 may store data or instructions and communicate with the encryption engine 80 securely. Cooperating with the encryption engine 80 are a random number generator 84, identification unit 86, a key memory storage area 88 and a key management algorithm storage 90. The random number generator 84 produces a number which will comprise a session key. The identification unit 86 will preferably store a unique identifier. The unique identifier will commonly comprise a microprocessor serial number or other identification number which will comprise the protected processor 30's public identifier. The key memory storage area 88 stores a unique, secret encryption key. Key management and use will be discussed below with respect to FIG. 10 and further figures.

The encryption engine 80 also acts as an instruction access controller 81. In operation, a microprocessor 94 will drive the instruction access controller 81 to produce an address to access a particular encoded instruction from the memory storage area 82, which stores encrypted instructions. The instruction access controller 81 may also command reading of keys from the memory 88.

The processor section 42 includes the microprocessor 94 which communicates with the encryption engine 80 via a port 92. The microprocessor 94 may include a data memory 96 and an instruction memory 98. The opcode conversion section 40 isolates the microprocessor 94 from outside communication. Consequently, unencoded instructions and data cannot be accessed by individuals seeking to reverse engineer the program performed by the protected processor 30. Additionally, unauthorized instructions cannot operate on the protected processor without being encrypted with the proper encryption key. Unauthorized instructions may include programs comprising viruses, worms or Trojan Horses.

The physical structure 44 may take any of a number of forms. In one embodiment, the physical structure 44 comprises an integrated circuit chip having the microprocessor 94 formed in the chip. Memories 82, 84, 86 and 88, the encryption/decryption unit 80 and the instruction access controller 81 may each be integral with the physical structure 44 or coupled thereto. In one form, the physical structure 44 comprises a controlling chip in a media player, for example a digital disc (DVD) player. The microprocessor 94 comprises storage devices to stored decrypted instructions as firmware.

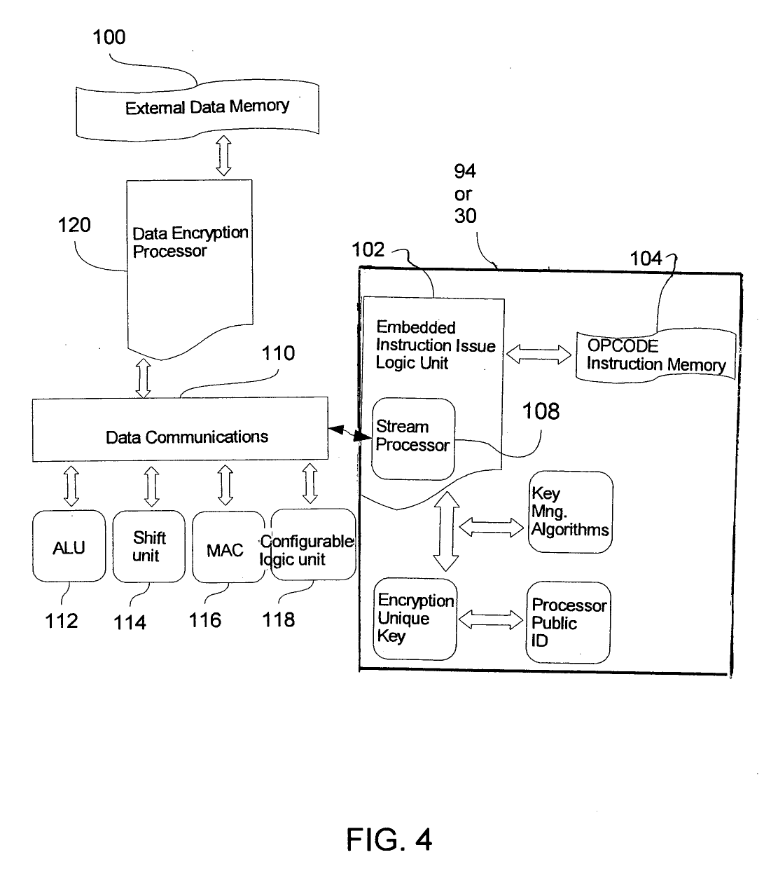

FIG. 4 is a block diagram illustrating a further form of protected processor 94 in which protected data may be stored outside of the protected processor 94 in an external memory 100. A reconfigurable logic array is used to encode instructions of data prior to encryption. In this manner, the encryption algorithm and other security elements are effectively varied. In FIG. 4, the same reference numerals are used to denote components corresponding to those in other figures. The microprocessor 94 is shown in greater detail. The microprocessor 94 comprises a unique opcode instruction memory 104 and an embedded instruction issue logic unit 102. The opcode conversion section 40 further comprises a stream processor 108. The stream processor 108 reconfigures instruction stream opcodes at the bit level as well as any interim results. Instruction words are not broken into neatly ordered sections. Each instruction is seemingly randomly placed. This is to be contrasted to prior art arrangements in which breaking words into ordered sections creates discernable patterns, thus weakening the strength of encryption.

In order to encode instructions prior to encryption, the embedded instruction issue logic unit 102 provides inputs to the stream processor 108. The stream processor 108 includes a data communications register 110. Manipulations on codes and data are performed using arithmetic logic units (ALUs), for example ALU 112, shift unit 114, a multiplier accumulator (MAC) 116 and a configurable logic unit 118. To accomplish this, the binary code is encrypted and decrypted as a part of the instruction pipeline. Data is directed from the data communications register to a data encryption processor 120. The data encryption processor 120 supplies encrypted data to the external memory 100. Interim data may be similarly encoded. Interim data includes ephemeral data produced in order to create a solution. Interim data does not comprehend the final results that are produced and presented to the user 7.

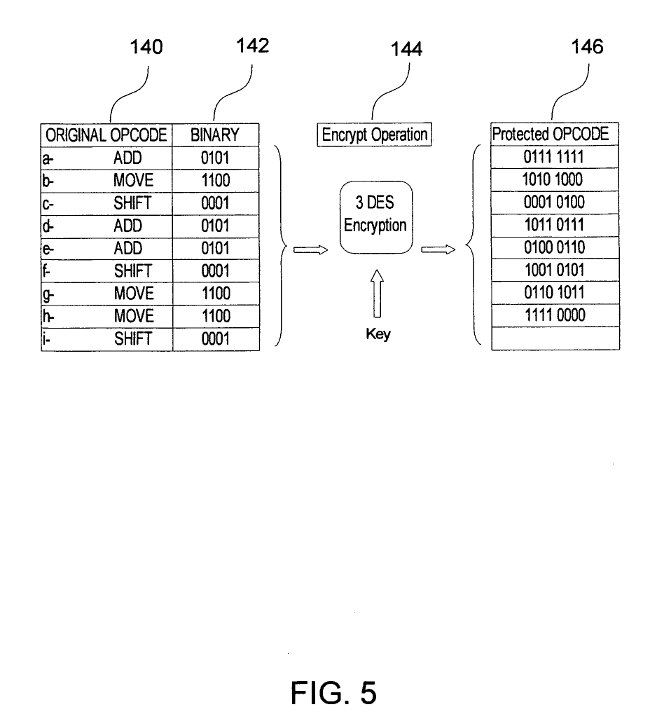

FIG. 5 is a chart illustrating the encryption of opcodes. In column 140, comprising a source code listing, a number of program steps are listed in each of rows a-i. Column 142, simplified for purposes of the present description, represents binary, or object code corresponding to each operation. In column 144, an encryption operation is illustrated. One possible form of encryption is 3DES encryption with a 168-bit key. Column 146 represents a sample set of encrypted instructions. As explained above, patterns are not created.

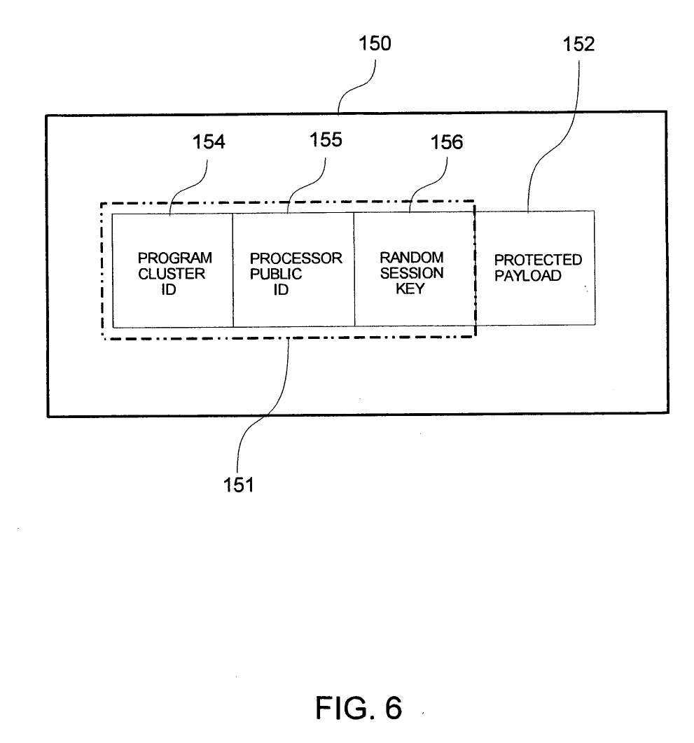

FIG. 6 is an illustration of an encrypted message 150 sent between workstations 2 in the network 1 of FIG. 1. The message 150 comprises a header 151 and a payload 152. The header 151 comprises a program cluster ID 154, processor public ID 155 and a random session key 156. Each element of the header 151 is encrypted with a key, preferably the key of the developer 3. The protected payload 152, which is the program code to be run on the processor, is encrypted with the random session key 156.

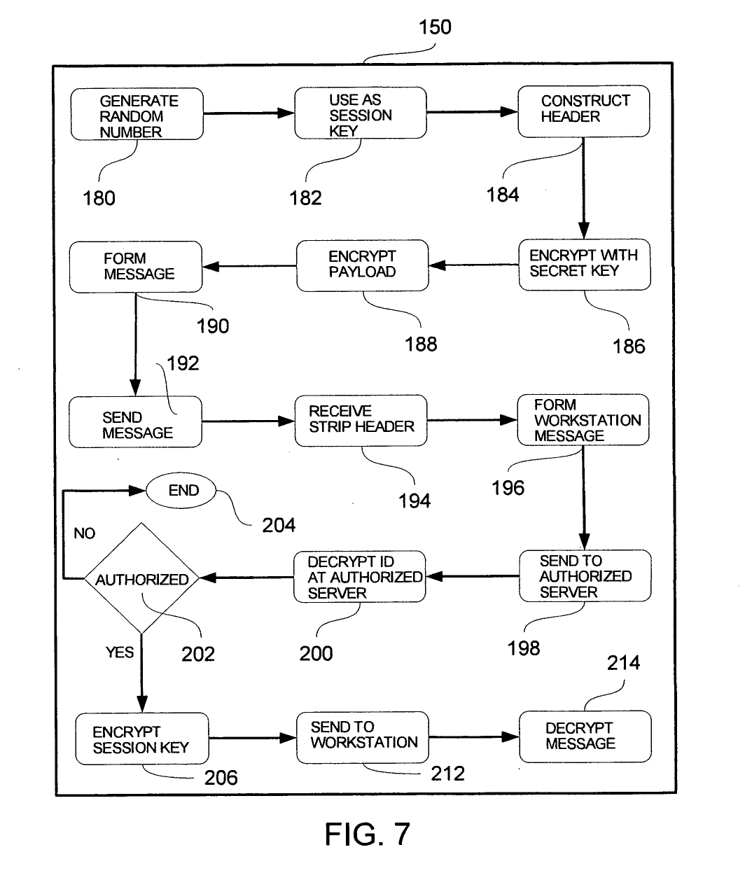

FIG. 7 is a flow chart illustrating construction of the message 150, transmission and authentication of a user's privilege to receive the message 150. Note that not all of the steps in FIG. 7 need be performed in the exact order shown. Changes may be made where equivalent operational results are not disabled. Operation in FIG. 7 is described with respect FIGS. 1 and 3. Each party, i.e., each member of a class of entity or each protected processor 30, registered to use the protected software has a unique secret key that is copied into the local or global authentication server 24.

The message 150 is initially constructed at the workstation 2a of the developer 3. At block 180, a random number is generated by the random number generator 84. The random number is selected for use as a session key, block 182. At block 184, the header 151 (FIG. 6) is constructed. The key is used to build a “protected header” that includes identity variables from the memory area 86 and a program cluster identification. The protected header 151 is encrypted with a developer 3's unique secret key from the memory 88 at block 186. The protected payload 152 comprises opcodes encrypted with the session key, block 188. The message 150 is assembled, block 190, and transmitted to another workstation, block 192. The transmission in this illustration is made to the workstation 2c.

The message 150 is received by the workstation. A procedure follows to assure that the workstation 2c is authorized to utilize the protected software. At block 194, the protected processor 94 in the workstation 2c strips the header 151 from the message, and produces a workstation message, block 196, for use by the authentication server 24. The workstation message to authentication server 24 is comprised of an encrypted copy of its public identity using the workstation's unique secret key (or individual's unique secret key operating the workstation), and is transmitted to the authentication server 24, block 198. The authentication server 24 receives both the protected workstation's (or person operating the workstation) identity information and protected header 151 and can open both, block 198. The identity information is decrypted, block 200. At block 202, the identity sent from the workstation 2c is compared to the authorized identity of the workstation 2c stored at the authentication server 24. If there is no match, operation ends, block 204, and the workstation 2c will not be able to use the protected software. If there is a match, the workstation 2c has been authenticated. In response to authentication, the session key from the protected header 151 is encrypted with the workstation 2c key, block 206, and the re-encrypted session key is sent back to the workstation 2c, block 212. At block 214, the workstation 2c decrypts the session key with its workstation key and then uses the session key to decrypt the protected software, and is able to use the protected software.

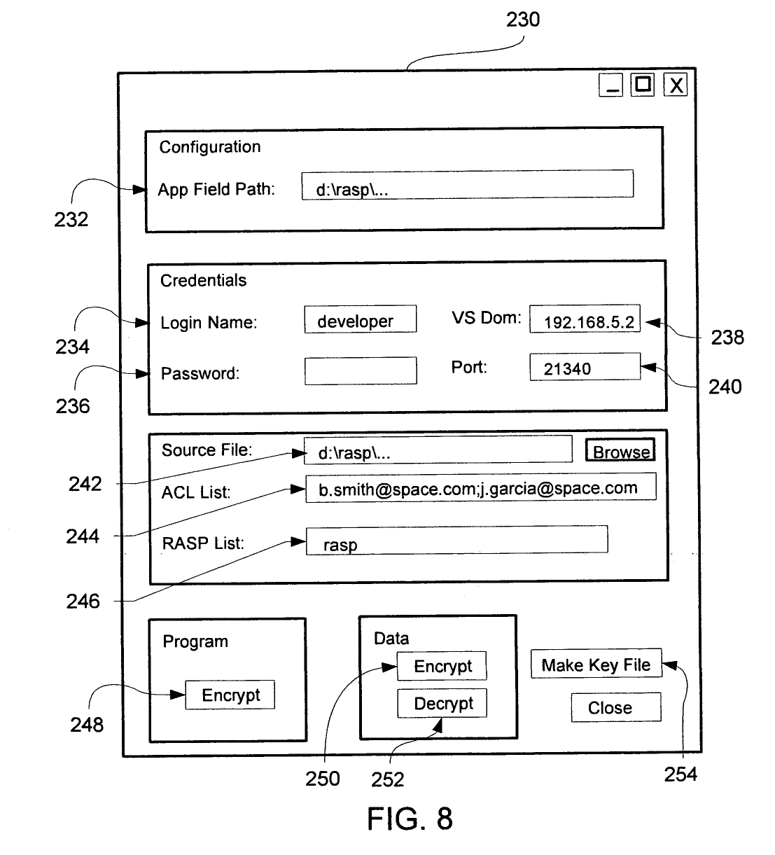

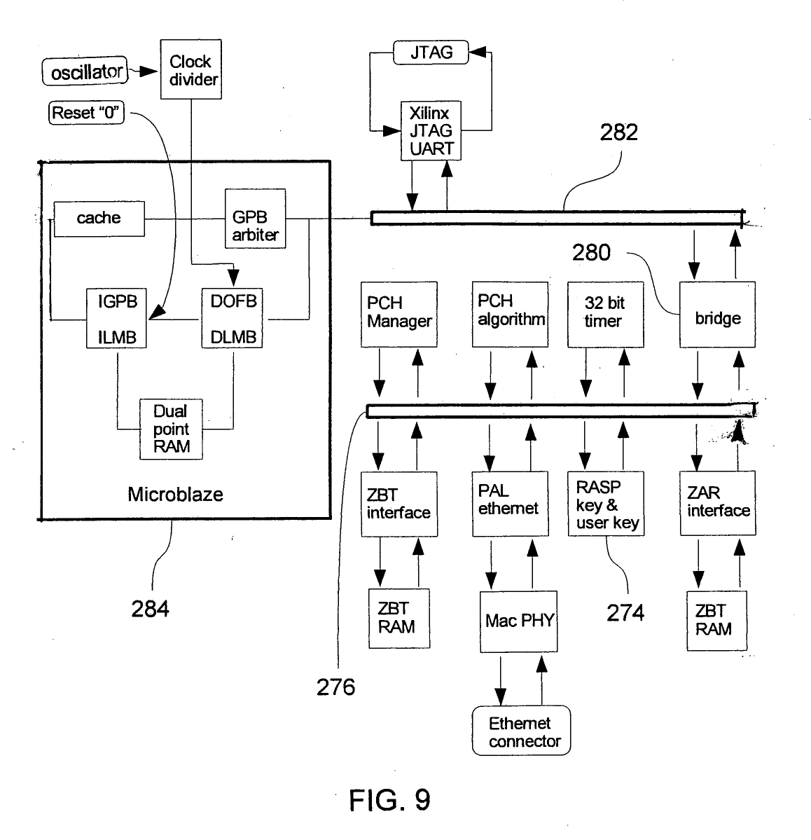

A further embodiment, described with respect to FIGS. 8 and 9, provides unique libraries of coding and decoding algorithms used by a developer for each binary source code and, if desired, each copy to a client. Objects, e.g., binary source code and/or datasets, are encoded, and encryption keys are automatically and easily delivered between parties. Users and administrators are provided with a simple method of authorizing access to a particular object, at the time of encryption. An access control list (ACL) is encrypted into the encrypted object. Upon the attempting of decryption, parties are granted or denied access based upon successful multi-factor authentication. If they were placed on the encrypted ACL by the software distributor, they gain access. Reconfigurable logic, e.g., an FPGA, in the opcode conversion section 40 receives a hidden, unique opcode encrypted payload and generates the standard opcodes for the microprocessor 94. The microprocessor 94 operates normally from its memory and caches, which are also behind the hidden, unique opcode barrier.

FIG. 8 is an illustration of a graphical user interface (GUI) 230 in an embodiment in which the opcode conversion section 40 comprises reconfigurable logic. Graphical user interfaces are commonly used in conjunction with software for programming reconfigurable logic such as FPGAs. FIG. 9 is a block diagram of one form of opcode conversion section 40 employed in this embodiment. The opcode conversion section 40 comprises, for example, FPGA 270. One form of FPGA 270 may comprise a Virtex II FPGA. In the present embodiment, industry standard symmetric encryption is used.

The GUI 230 allows a user such as a developer to set up an access control list, define a file to be secured and perform other administrative functions, as well as defining encryption and decryption sequences. The GUI 230 comprises a field 232 for a developer to select a file location for an encryption key. The developer may log in, entering a user name in field 234 and a password at field 236. In a typical system, software will fill the user's IP address (Internet location) in a field 238 and identify a current communications port in a field 240. A file that contains a program to be secured is identified in field 242. The access control list (ACL) is entered in field 244. In the present illustration, access is specified in terms of client email address. Other identifiers, e.g., IP address could be utilized. In field 246, authorized processors are identified. Authorized processors can be identified by unique serial number, IP address or unique strings. A process email address may be constructed to identify a particular processor in a particular organization or facility, e.g., processor123@army.mil. Many other forms of identifier construction may be used. The GUI 230 may be written to provide a field 248 to select encryption of a program. Fields 250 and 252 are respectively used to command encryption or decryption of data. Field 254 may be used to access a facility to create a client key for each client. A list of all client keys is provided to the authentication server 24.

FIG. 9 illustrates an FPGA supporting a developer and user key encryption and decryption unit 274. Symmetric encryption algorithms are utilized. A data bus 276 connects the unit 274 for interaction with processor management components 288 and a bridge 280. The bridge 280 connects the bus 276 to a soft processor 284 via a bus 282. The above discussion references encryption keys and their distribution. Prior art schemes for key management are subject to shortcomings. These schemes will be reviewed prior to discussion of a further embodiment comprising key distribution described below with respect to FIGS. 10-14.

In one prior form of encryption, secret symmetric keys are used. In systems using secret symmetric keys, a unique secret key for each node of the system, e.g., workstation 2, is provided. Secure transmission from a developer to a node generally requires a physical transfer of keys. Physical transfer may be difficult and expensive, and is subject to security problems, e.g. codebooks get stolen. Individual secret keys are almost impossible to manage and distribute, so they are usually grouped into blocks. Each processor will only allow one group to utilize it, which is not feasible; and if one key is compromised, the entire security is lost. There are variations, such as time based rolling keys, but they have the same problems.

A more current, common form of encryption and decryption uses server symmetric keys. Every node in the system can have a unique key, and a server manages the transactions between parties and assists in authenticating parties and authorizing encryption keys. Examples of these systems are Kerberos and Radius servers. These systems work, but are subject to hacking. Long delays are required between parties authenticating. These systems require both parties to communicate with an authorizing server. Additional steps must be employed. These systems are primarily for suited large networks where individuals are exchanging data. These types of systems rely on the fixed nature of the processor, with a secured database at all ends of the system to be secure. In preferred embodiments, a processor is reconfigurable. External databases adjacent the protected processor 94 end are not secure; they rely on using encrypted data. Therefore, this type of system is not desirable for preferred embodiments.

A popular form of encryption uses asymmetric keys, referred to as public and private keys. Every node in the system would hold a unique private key and would publish their matching unique public key. The public key of the receiving party (the processor) must be used to encrypt the opcodes. All protected opcodes would have to be addressed to a specific protected processor 94 where the calculations are to be performed. Changes to the processor would have to be made and approved by the source of the protected information (developer 3 for algorithms and user 7 for data). In a scenario that occurs from time to time, an intruder may post a fake public key with a valid identity. A certifying authority must provide a certification for each node. Additionally if multiple processors are authorized for a protected software package, each unique processor needs to have a unique encrypted software package, or multiple encrypted session keys, built for each public key. These requirements add very significant overhead to the system.

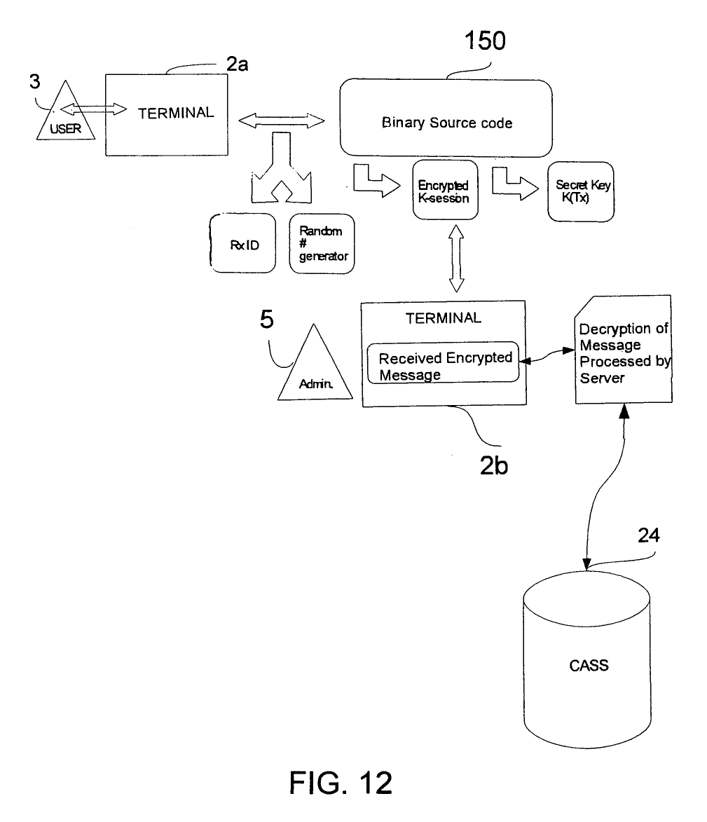

FIG. 10 illustrates architecture of an embodiment comprising an encryption key management system that uses standard symmetric encryption algorithms, e.g., 3DES or AES, and that cooperates with an authentication server to verify parties and to pass unique session keys between parties. Each entity or microprocessor has a unique secret key that is copied into the local or global authentication server 24 (FIG. 1). This key is used locally to build a “protected header” further discussed below with respect to FIG. 12. The header includes some public identity variables of which protected processor 94 or user 7 identity is being transmitted and of the session encryption key that encrypts the protected opcodes. The protected header is encrypted with the sender's unique secret key. The header and protected opcodes can now be transferred and will be protected even if intercepted on a network such as the Internet or stored on a CD medium that is stolen.

While encryption that utilizes keys is used for encrypting messages, it has been regarded as undesirable for use in protecting software source code. Various factors have led to view such encryption undesirable. Before the computer executes the program, it must have the unencrypted program existing in memory somewhere. Snapshots can be taken of memory, providing access to the source code. Strong encryption requires a key for decryption. Storage location of the key is critical. If the key is stored somewhere in the program or local memory, it can be found and the source code can be exposed. Transfer and management of encryption keys are critical. Overly cumbersome key management technologies create “unworkable” systems, that people cannot use. Compliance then becomes a major issue and both shortcuts (failure to use the encryption) and “mistakes” (sending plaintext key with encrypted source code) occur, compromising the security of the system.

The present embodiments avoid these perceived drawbacks. Decrypted binary instructions or data are placed in local memory in encrypted form. Consequently, if an unauthorized party accesses the stored binary information. The encryption can also be extended to include interim results or data sets.

In the embodiment of FIG. 10, a protected processor 300 is coupled to an interface 310. The interface 310 provides connections to storage location and to communications networks. The protected processor 300 includes an encryption/decryption section 320 and a processor 322. The processor 322 operates without encryption. To indicate this operation, the processor 322 will be referred to as the open processor 322. A memory interface 332 is intermediate the interface 310 and encryption and decryption modules. Decryption modules 334 and 336 receive encrypted data for decryption and provide decrypted inputs to an internal cache 338. The internal cache provides inputs to the open processor 322. Plain text instructions are executed by the open processor 322. The open processor 322 may request further information from the cache 338 by sending a signal to an intercept circuit 342, which addresses the cache 338. Information is sent to encryption circuits 344 and 348 from the intercept circuit 342 and the open processor 322 respectively. The encryption circuits 344 and 348 send encrypted information to the internal cache 332 for provision to the interface 310.

Encrypted source code instructions are encrypted and decrypted by the encryption and decryption units 334 or 336 respectively for provision to the open processor 322. Plaintext instructions are then run on the open processor 322. All interim data results and/or instructions that do no fit into the secure cache 338 can be transferred to local memory through encryption units 344 and 348.

The present embodiment avoids prior art issues with respect to embedding the encryption key within the source code. The session encryption key can be securely sent by normal transmission, since the key is encrypted by the developer's encryption key. Once the encryption key is received at a computing platform 20 (FIG. 1) secure storage must be provided for the key.

The present embodiment in one form stores encryption keys inside of the open processor 322 in reconfigurable or programmable (one or more times) logic, for example of the type used in FIG. 4. Appropriate forms of reconfigurable logic include a programmable read only memory (PROM), electrically erasable PROM (EEPROM) or an EEPROM which is securely expanded into static random access memory (SRAM) FPGAs. A key inside of the open processor 322 is not accessible to outside entities attempting to read it. Hardware storage of encryption keys can be for both session keys and unique individual keys for both processors and/or human entities.

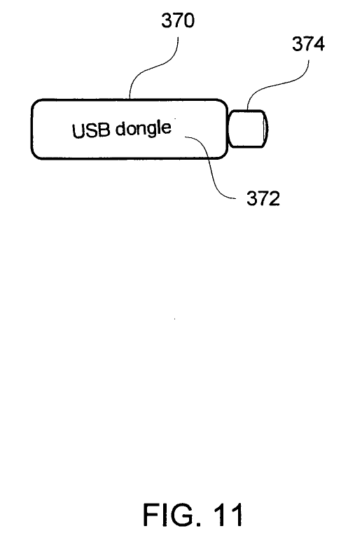

Another form of the present embodiment utilizing the portable memory device illustrated in FIG. 11 provides for both the storage and transfer of encryption keys between parties. A unique “secret” encryption key is programmed into the open processor 322, typically an EEPROM or PROM. This key is unique to each protected processor. Also, a separate, unique secret key, a client key, is assigned to every human entity. The client key can be stored in hardware within the client's protected processor, as a second key, or in a hardware “key fob” 370 illustrated in FIG. 11. An example of a key fob 370 comprises a housing 372 containing memory coupled to an interface terminal 374. A currently popular form of interface terminal is a USB memory stick. If the security level of the client's computer is deemed adequate, it is also possible to store the client key in software on the development computer such as the workstation 2a of FIG. 1. However, in most environments, unencrypted software on a workstation is not regarded as secure.

Each open processor 322 must be initialized with an encryption key. For example, a key may be programmed into an EPROM during the manufacturing of the open processor 322. At the same time, the encryption key is copied into the Customer Authentication Secure Server, or CASS, database, which may be contained in the authentication server 24 (FIG. 1). The encryption keys are then registered by a person through connection to the authentication server 24. An approved identity that will be mated to the encryption key is initialized. Usually this is completed by a network administrator 5 including the use of additional authentication variables. Security of this registration process is easily achieved, because a copy of the key is already in both the protected processor and the CASS database in the authentication server 24, allowing the registration to be an encrypted communication. The critical key is now securely stored into a hardware element, where it can be used by the protected processor and can be associated with an approved person operating the protected processor. During registration, a unique public identity is provided for each protected processor, which is then stored with the unique encryption key as a matching pair in CASS.

Storage of a unique “secret” key for both each protected processor hardware element and each client allows a mechanism for the transfer of a session key between clients and protected processor hardware. By using a unique key for each entity, compromise of a single key only affects the individual data protected with that key, not the whole system. Two parties, people or computers, are enabled to transfer and/or store encrypted information without knowing the other party's encryption key. The only information required to transfer between parties is the sender must know the public identity of the recipient, which can be any unique identity. Different forms of public identities which are utilized include CPU public serial number, IP address or a client's e-mail address.

Operation is described with respect to FIG. 12, which is a functional block diagram. The scenario described with respect to FIG. 12 assumes that the above-described initialization of processors 322 and registration of parties (processors and human entities) has been completed. A sender, e.g., the software developer 3 in the present illustration is sending information to a receiver. The receiver could comprise the administrator 5, for example. The information may comprise binary source code to run a high performance program on a platform 20 included in a message 150 (FIG. 6). The sender may use a graphical interface of the sort illustrated in FIG. 8 to command encoding of the information, as by pressing an icon. The sender provides the public identity (Rx ID) of the party allowed to have access to the data (this can be individuals, groups and/or computers; and can be automated to be selections off a list). A random number generator in the protected processor 2a generates a random number. The random number is selected to be a current session key (Ksession). The information is encrypted with K(session). A payload is thus provided. Next, both the receiver's public ID, in this case the identity, or Rx CPU ID, of the protected processor 30 in the workstation 2b, and the session key (Ksession) are encrypted with the transmitter's (workstation 2a) unique “secret” key K(Tx). To complete formation of a header, the public identity of the sender (Tx ID) is added as plaintext. The encrypted session key, encrypted receiver's public ID and the plain text sender ID comprise a header. The message is sent to the receiver, workstation 2b, in the present illustration.

The message received at the workstation 2b cannot be opened because the protected processor 300 does not have the ability to decrypt K(session), which has been encrypted with K(Tx). K(Tx) is stored only in the sending workstation and by the authentication server 24. The workstation 2b sends the message header to the authentication server 24. In addition, the receiver CPU encrypts its own public identity (Rx CPU ID) with its own CPU unique secret key (K(CPU Rx), stored in its protected processor EEPROM memory. A plain text copy of the public Rx CPU ID of the receiver is added to the encrypted Rx CPU ID to become the receiver's header or Rx Header.

The authentication server 24, has access to both K(Tx) and K(CPU Rx) in its secure database, by reading each header's unique public ID, then looking up each encryption key that is paired with the public in the CASS database. Once the Tx and Rx encryption keys are determined by the authentication server 24, they are used to decrypt both Headers to reveal their internal identities. The authentication server 24 compares the receiver's identity that was put into the Tx Header by the sender with the requesting party's identity put into the Rx Header. If they match, the receiver is authenticated. Additional authentication variables in both Tx and Rx Headers are utilized in alternative forms. The authentication server 24 is also able to access the session key for the Data (in Tx Header) and then re-encrypts K(session) with the receiver's key (K(CPU Rx)) and sends it back to the receiver as the Session Key. If they do not match, the transaction is terminated.

The receiver CPU then decrypts the Session Key with its own encryption key (K(CPU Rx)) and has access to the Data by decrypting with K(session). The encryption key transfer process has now been successfully and securely completed, without either party knowing each other's encryption key.

If the CASS database is accessed, the system will be insecure. Security of the CASS key database is provided by making the CASS server from a dedicated protected processor hardware element. Then the database is stored as encrypted data, where the only function of the CASS protected processor is to run the code especially encrypted for it. However, the authentication server 24 is programmed so that it does not perform a process of authenticating itself. A traditional secret key is used and programmed into the protected processor 30d of the authentication server 24.

As in message encryption environments, the secret key of the authentication server 24 can be split into partial key lengths. Each partial length may be provided to separate individuals. This will prevent a single individual from having knowledge of the secret key. The partial lengths are then programmed into the CASS protected processor hardware, which is presumably stored in a very secure location. Since the encryption keys never leave the protected processor hardware and encryption/decryption is completed inside of the protected processor, the only method of cracking this secret key is stealing the CASS protected processor and physically reverse engineering the key out of the chip without anyone noticing the CASS protected processor is missing or off-line. For recovery of the secret key in case the CASS protected processor fails, the partial keys can be written down and stored in a physically secure location.

The construction of the header 150 and the operation of the embodiment of FIG. 12 provides a method for protecting a program in a microcomputer such as the workstation 2a, in which at least one region of the protected program, is enclosed in a memory together with a key necessary for the decoding thereof. The enciphered region is decoded using the key at the time when the region is accessed. At this time, key is in an enciphered form. The protected program is divided region into a first program region necessary for initialization of the microcomputer system and a second program region excluding the first one, enciphering only said second program region, and acquiring the decode key within the period between completion of the initialization process and transfer of the control process to said second program region.

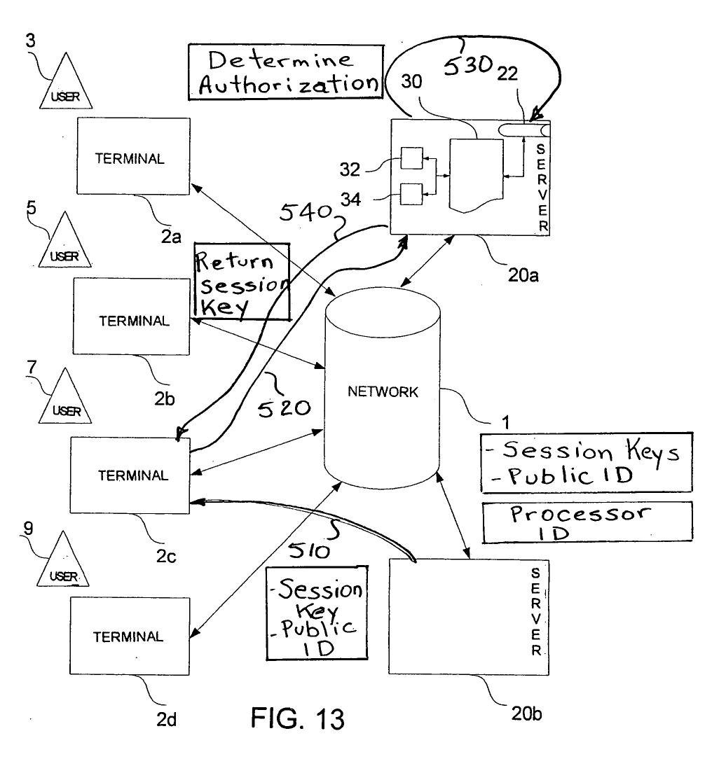

FIG. 13 is a block diagram illustrating provision of a key to a work station in response to transmission of an opcode by an authorized user. Signal paths 510, 520, 530, and 540 are superimposed on a reproduction of FIG. 1. FIG. 13 further illustrates the operation recited in more detail with respect to FIG. 7. The signal path 510 illustrates provision of a session key and public ID to the user 7 at terminal 2b. In signal path 520, a session key and a public ID are sent to the authentication server 24. Also transmitted is a processor ID associated with the terminal 2b. This processor ID is used for authentication. The processor ID is read or detected to determine if the terminal 2b is authorized to connect. Comparison with a table or other form of determination may be done. Signal path 530 illustrates identification of an authorized connection, and encryption of a session key. The session key is sent to the terminal 2b in signal path 540

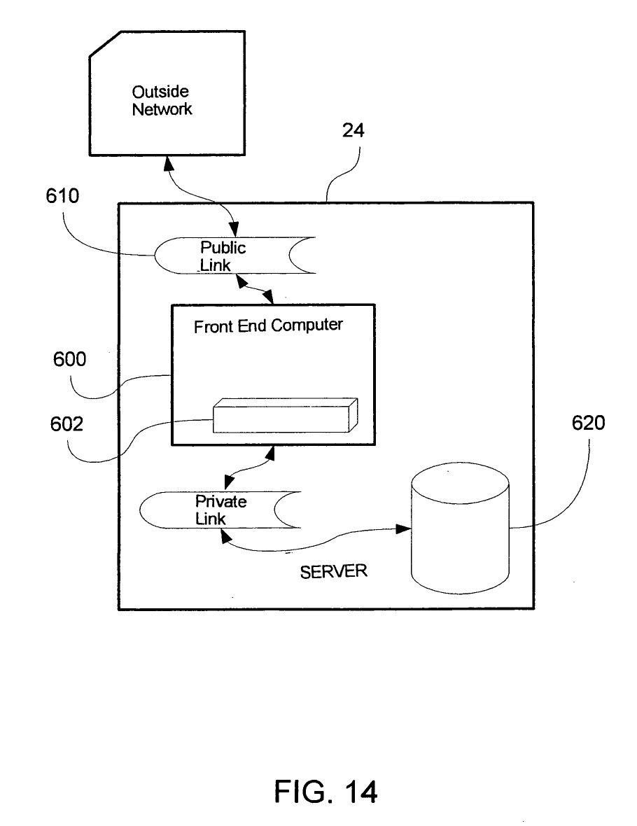

One form of authentication server 24 is illustrated in FIG. 14. The authentication server 24 comprises a computer 600, referred to as a front end computer 600. A public link 610 couples the front end computer 600 to outside networks. A suitable operating system comprises hardened Red Hat Linux distribution with the NSA security patches. A database server storing protected information 620 is on a protected side of the computer 600 and coupled by a private link. At startup, the front end computer 600 boots, i.e., loads software to RAM, from a CD 602. No party is given write access to the file systems in the computer 600. The CD 602 needs to be created on a secure and trusted system. Communication via the public link 610 occurs through fully “encrypted discussion.”

The front end computer 600 is dedicated to running its internal software and is the only computer with the ability to connect to the database server 620. The database server 620 is dedicated to keeping the keys, machine data, and user 7 data secure. The database server 620 cannot use processing capabilities of the front end computer 600. A single encryption key will be programmed into the protected processor hardware of the database server 620. Protection of this key requires trusted personnel to perform programming into the protected processor and storing the key for recovery in case of hardware failure. This key can be generated in parts and provided to multiple individuals in parts. Also, the encryption key can also be periodically rotated.

Embodiments of the present invention may comprise any computing platform including Linux clusters, supercomputers, high throughput computer (Sparc workstations), standard “personal” computers (PCs), handheld computers and/or reconfigurable hardware computing platforms. Development environment include commercially available, standard software or reconfigurable hardware development toolsets. Integration of the protected processor architecture starts at the processor hardware level and moves through the computer system and finally through to the client. This is necessary since compromise of the opcodes can occur in multiple places, such as processor storage, communication of software and data or at the client site.

The present subject matter being thus described, it will be apparent that the same may be modified or varied in many ways. Such modifications and variations are not to be regarded as a departure from the spirit and scope of the present subject matter, and all such modifications are intended to be included within the scope of the following claims.

1. A method of utilizing an encrypted instruction, the method comprising:
providing an opcode from a microprocessor to an instruction issue logic unit;
determining an identity associated with an entity providing the opcode;
providing a key in response to a determination that the identity is an authorized identity;
accessing the encrypted instruction;
decrypting the encrypted instruction with the key to generate a decrypted instruction; and
providing the decrypted instruction to the microprocessor to operate according to the decrypted instruction.

2. A method according to claim 1, wherein the step of decrypting the encrypted instruction further comprises providing a register module; and driving the register module to store the encrypted instruction accessed by the instruction access controller.

3. A method according to claim 1, further comprising providing a key memory to store a key; wherein the step of decrypting the encrypted instruction further comprises reading the key to decrypt the encrypted instruction.

4. A method according to claim 3, wherein the step of accessing the encrypted instruction further comprises reading the key to decrypt the access address of the encrypted instruction.

5. A method according to claim 1, wherein the instruction access controller and the microprocessor are located on a chip; and wherein accessing the encrypted instruction comprises accessing the encrypted instruction from a memory coupled to the chip.

6. A method according to claim 5, wherein accessing the encrypted instruction comprises accessing the encrypted instruction from a memory on the chip.

7. A secure processor comprising:
an operation code conversion unit; and
a processor unit;
said operation code conversion unit being responsively coupled to provide access to and from said processor unit at one port thereof when authorized access is sought, and receiving and providing encoded data at another port thereof, said processor unit being isolated from connections outside of said secure processor;
said operation code conversion unit comprising an encryption engine to perform encryption and decryption; and
an encryption key management unit coupled to said encryption engine, said encryption key management unit being responsively coupled to provide a key in response to authorized access.

8. A secure processor according to claim 7, further comprising: a memory module coupled to said encryption engine to store data and to provide a data source for said encryption engine to provide decrypted data to said processor and encrypted data to said input/output port and an instruction access controller to access and direct stored instructions.

9. A secure processor according to claim 8, wherein said operation code conversion unit functions as a cache memory.

10. A secure processor according to claim 9, further comprising a key storage unit coupled to the decryption module for storing a key, wherein the decryption module reads a key stored in said key storage unit to decrypt the encrypted instruction.

11. A secure processor according to claim 7, further comprising: a key storage unit connected to the instruction access controller for storing a key; wherein the instruction access controller reads the key to decrypt an access address of an encrypted instruction.

12. A secure processor according to claim 8, wherein said instruction access controller, said decryption module, and said microprocessor are located in a chip, and said storage apparatus is connected to said chip.

13. A secure processor according to claim 12, wherein said memory module comprises a non-volatile memory.

14. A secure processor according to claim 12, wherein said chip is a controlling chip of a disc player, and the decrypted instruction is a firmware of the disc player.

15. A secure processor according to claim 8, wherein the memory module, the instruction access controller, the encryption engine, and the microprocessor are located in a chip,

16. A secure processor according to claim 15, wherein the storage apparatus is a volatile memory.

17. A secure processor according to claim 15, wherein the chip is a controlling chip of a disc player, and the decrypted instruction is a firmware of the disc player.

18. A method for protecting a program in a microcomputer, the method comprising enciphering at least one region of the program, enclosing the program in a memory together with a key necessary for the decode thereof, and decoding said enciphered region using said key at the time when the region is accessed.

19. The method of claim 18 wherein said key is an enciphered key.

20. The method of claim 18, further comprising dividing the program region into a first program region necessary for initialization of the microcomputer system and a second program region excluding the first one, enciphering only said second program region, and acquiring the decode key within the period between completion of the initialization process and transfer of the control process to said second program region.

21. The method of claim 19, further comprising dividing the program region into a first program region necessary for initialization of the microcomputer system and a second program region excluding the first one, enciphering only said second program region, and acquiring the decode key within the period between completion of the initialization process and transfer of the control process to said second program region.

22. A system for secure transmission of a program comprising opcodes comprising:
a receiver to receive a first message including a protected header and a protected payload, said payload comprising opcodes and being encrypted with a key;
a message generator in said receiver to construct a second message to send to an authentication server, said second message comprising an identification field of a processor in said receiver and said encrypted payload;
an authentication server comprising a database of authorized users and further comprising means to compare the identification field to the database of authorized users and further comprising a key database, said authentication server comprising means to generate a message to said receiver, said message comprising the key to the first message; and
a decoder in said receiver to decrypt the first message with the key.

23. A system according to claim 22 further comprising a program source producing said first message comprises an encoding program cluster ID, public processor ID and a random session key in a header of the first message.

24. A system according to claim 23 wherein said program source encodes the payload with a current session key and further comprises a random number generator to produce a value for the current session key.

25. A system according to claim 24 further comprising means to encode opcodes prior to encryption.

26. A system according to claim 23 wherein said processor is configured to download programs only included in messages containing the identification field of said processor.
